(19) United States
(12) Patent Application Publication
(10) Pub. No.: US 2014/0121863 A1
(43) Pub. Date: May 1, 2014

(54) Flight Envelope Display

(71) Applicant: THE BOEING COMPANY, Chicago, IL (US)

(72) Inventor: Nima Barraci, Frankfurt am Main (DE)

(73) Assignee: The Boeing Company, Chicago, IL (US)

(21) Appl. No.: 13/662,865

(22) Filed: Oct. 29, 2012

(51) Int. Cl. B64D 43/00

(52) U.S. Cl. 701/14

(57) ABSTRACT

A method and apparatus for displaying aircraft performance characteristics. A two-dimensional representation of a flight envelope for an aircraft is displayed. The two-dimensional representation of the flight envelope comprises a display of speed versus altitude performance capabilities of the aircraft. A current speed and a current altitude of the aircraft are identified. A performance indication of the current speed and the current altitude is displayed on the two-dimensional representation of the flight envelope. A position of the performance indication on the two-dimensional representation of the flight envelope indicates the current speed and the current altitude with respect to the flight envelope.

### BACKGROUND INFORMATION

1. Field

The present disclosure relates generally to systems and methods for displaying the performance of an aircraft to a flight crew during a flight of the aircraft. More particularly, the present disclosure relates to displaying the current performance of an aircraft during flight with respect to a representation of a flight envelope or other performance capabilities of the aircraft.

2. Background

The flight envelope of an aircraft may refer to the capabilities of the aircraft in terms of airspeed and load factor or altitude. The flight envelope also may be referred to as the service envelope or performance envelope. In some cases, the flight envelope may refer to the physical limits of the capabilities of the aircraft. In this case, the aircraft cannot be operated outside of the flight envelope.

In other cases, the flight envelope may refer to a limit within a threshold from the physical limits of the capabilities of the aircraft. For example, in this case, the flight envelope may be selected to provide a margin of safety between the flight envelope and the physical limits of the capabilities of the aircraft. In some cases an aircraft may be certified for operation within such a flight envelope that provides a margin of safety between the flight envelope and the physical limits of the capabilities of the aircraft. In any case, it may be desirable that an aircraft is not operated outside of a flight envelope that provides a margin of safety between the flight envelope and the physical limits of the capabilities of the aircraft.

Flight envelope protection may be provided in some form in modern commercial fly-by-wire aircraft and other aircraft. Flight envelope protection may be implemented as an extension of an aircraft control system that may prevent the pilot of the aircraft from making control commands that would force the aircraft to exceed its structural and aerodynamic operating limits. For example, flight envelope protection may identify the aircraft flight envelope, including a margin of safety, and use this information to stop pilots from making control inputs that would put the aircraft outside the flight envelope. Flight envelope protection may increase aircraft safety by allowing the pilot to apply maximum control forces in emergency conditions while the flight envelope protection prevents the pilot from inadvertently driving the aircraft outside of the limits of operational safety.

A stick shaker may be an example of flight envelope protection that may be used on some aircraft. The stick refers to an apparatus that is moved by the pilot to control the aircraft. The stick shaker may be activated to shake the stick to provide a warning to the pilot when the aircraft is operated at a speed or altitude that may be close to the performance limitations of the aircraft.

On many commercial and other aircraft the current speed and altitude of the aircraft may be displayed on moving tape displays. These tape displays may be part of the primary flight display on the flight deck of the aircraft. Indications may be provided on the tape displays to indicate to the pilot whether it is safe to operate the aircraft at a given speed and altitude. The positions of the indications on the tape displays may depend on the current configuration of the aircraft, such as the current configuration of the aircraft flaps.

Current systems and methods may provide for warning a pilot when an aircraft is being operated near the flight envelope limits or for preventing the pilot from operating the aircraft outside of the flight envelope. Current systems and methods may display the current speed and altitude of the aircraft to the pilot along with indications of the speed and altitude performance capability limitations of the aircraft. However, current systems and methods do not provide an indication to the pilot of where the aircraft is currently operating within the flight envelope until the aircraft is operated near the limits of the flight envelope.

Accordingly, it would be beneficial to have a method and apparatus that takes into account one or more of the issues discussed above as well as possibly other issues.

### SUMMARY

An illustrative embodiment of the present disclosure provides a method for displaying aircraft performance characteristics. A two-dimensional representation of a performance envelope indicating performance capabilities of an aircraft is displayed. A current performance of the aircraft is identified. A performance indication of the current performance with respect to the performance envelope is displayed on the two-dimensional representation of the performance envelope. A position of the performance indication on the two-dimensional representation of the performance envelope indicates the current performance with respect to the performance envelope.

Another illustrative embodiment of the present disclosure provides an apparatus comprising a current performance identifier and a display generator. The current performance identifier is configured to identify a current performance of an aircraft. The display generator is configured to display a two-dimensional representation of a performance envelope indicating performance capabilities of the aircraft and to display a performance indication of the current performance with respect to the performance envelope on the two-dimensional representation of the performance envelope. A position of the performance indication on the two-dimensional representation of the performance envelope indicates the current performance with respect to the performance envelope.

Another illustrative embodiment of the present disclosure provides another method for displaying aircraft performance characteristics. A two-dimensional representation of a flight envelope for an aircraft is displayed. The two-dimensional representation of the flight envelope comprises a display of speed versus altitude performance capabilities of the aircraft. A current speed and a current altitude of the aircraft are identified. A performance indication of the current speed and the current altitude is displayed on the two-dimensional representation of the flight envelope. A position of the performance indication on the two-dimensional representation of the flight envelope indicates the current speed and the current altitude with respect to the flight envelope.

The features, functions, and benefits may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 is an illustration of a block diagram of an aircraft performance display system in accordance with an illustrative embodiment;

FIG. 2 is an illustration of a flight envelope display in accordance with an illustrative embodiment;

FIG. 3 is an illustration of a turn rate envelope display in accordance with an illustrative embodiment;

FIG. 4 is an illustration of a combined flight envelope and turn rate envelope display in accordance with an illustrative embodiment;

FIG. 5 is an illustration of a flowchart of a process for displaying aircraft performance in accordance with an illustrative embodiment; and

FIG. 6 is an illustration of a block diagram of a data processing system in accordance with an illustrative embodiment.

### DETAILED DESCRIPTION

The different illustrative embodiments recognize and take into account a number of different considerations. “A number”, as used herein with reference to items, means one or more items. For example, “a number of different considerations” means one or more different considerations.

The different illustrative embodiments recognize and take into account that current systems and methods may not allow the flight crew of an aircraft to assess current aircraft performance characteristics during a flight with respect to the performance capabilities of the aircraft as represented by the currently applicable flight envelope. Currently, the flight crew may not be able to identify where the aircraft is operating within the flight envelope without having to manually or mentally combine information from a variety of different sources.

The illustrative embodiments provide a system and method for displaying an indication of the current performance of an aircraft overlaid on a representation of the currently applicable flight envelope. Illustrative embodiments therefore improve the situational awareness of the flight crew regarding the current flight envelope and the current performance of the aircraft with respect to the flight envelope.

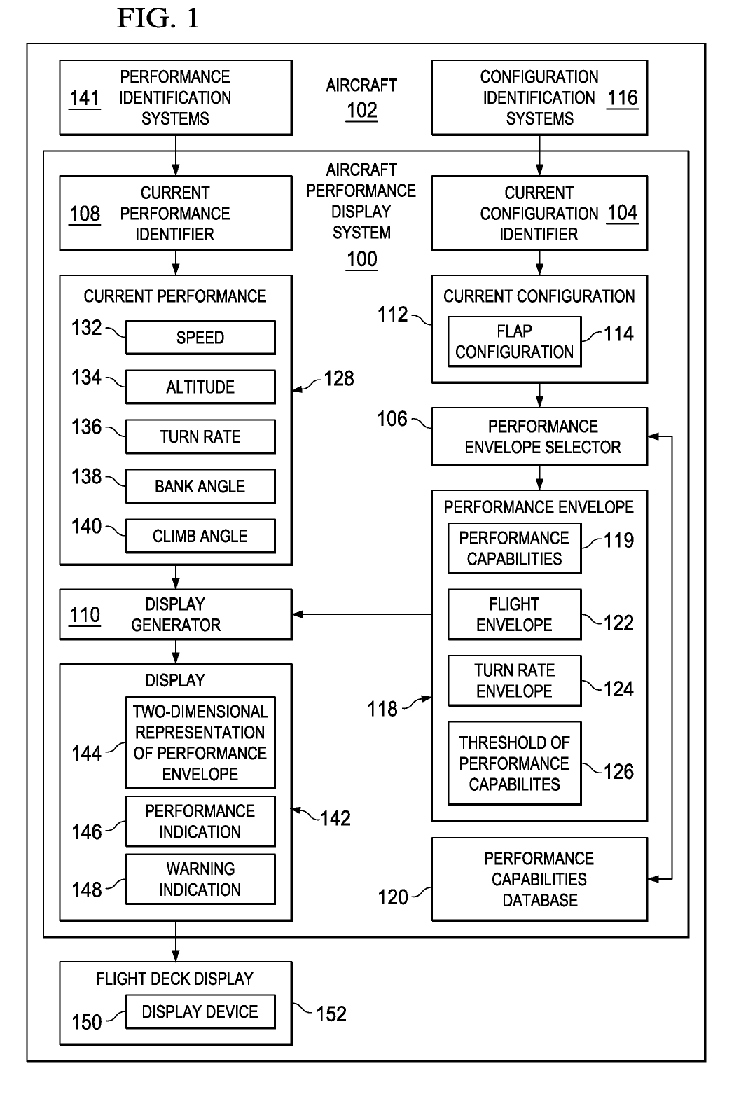

Turning now to FIG. 1, an illustration of a block diagram of an aircraft performance display system is depicted in accordance with an illustrative embodiment. In this example, aircraft performance display system 100 may be a system for displaying aircraft performance characteristics for aircraft 102.

Aircraft 102 may be any vehicle configured for traveling through the air. For example, without limitation, aircraft 102 may be a fixed or rotary wing aircraft or a lighter than air vehicle. Aircraft 102 may be an aerospace vehicle configured for traveling through the air and in space. In this case, illustrative embodiments may be used to display performance characteristics of the aerospace vehicle while the vehicle is being operated in the atmosphere. Aircraft 102 may be a manned aircraft or an unmanned air vehicle.

Aircraft performance display system 100 may be implemented in a data processing system on aircraft 102. For example, without limitation, some or all of the functions performed by aircraft performance display system 100 as described herein may be implemented in software running on a data processing system on aircraft 102. Alternatively, some or all of the functions performed by aircraft performance display system 100 as described herein may be implemented in hardware on aircraft 102.

Some or all of the functions performed by aircraft performance display system 100 as described herein may be implemented on a data processing system, other hardware, or both, that is not on aircraft 102. For example, in the case where aircraft 102 is an unmanned air vehicle, a portion of aircraft performance display system 100 may be implemented on a data processing system, other hardware, or both that is not on aircraft 102. In this case, aircraft performance display system 100 may be configured for displaying aircraft performance characteristics for use by a pilot or other operator for remote control of aircraft 102 from a location that is not on aircraft 102.

Aircraft performance display system 100 may comprise current configuration identifier 104, performance envelope selector 106, current performance identifier 108, and display generator 110.

Current configuration identifier 104 may be configured to identify current configuration 112 of aircraft 102. Current configuration 112 may refer to any current characteristics of aircraft 102 that may affect the performance capabilities of aircraft 102. For example, current configuration 112 may refer to the current characteristics of any changeable characteristics of aircraft 102 that may be changed to affect the performance characteristics of aircraft 102. For example, without limitation, current configuration 112 may include flap configuration 114. In this case, flap configuration 114 may refer to the current flap settings on aircraft 102.

Current configuration identifier 104 may be configured to identify current configuration 112 using information provided by configuration identification systems 116 on aircraft 102. Configuration identification systems 116 may include any systems or devices on aircraft 102 that may provide information on the current characteristics of aircraft 102 that may affect the performance capabilities of aircraft 102.

Performance envelope selector 106 may be configured to select performance envelope 118 for current configuration 112 of aircraft 102. Performance envelope 118 indicates performance capabilities 119 of aircraft 102 for current configuration 112. For example, without limitation, performance envelope selector 106 may be configured to select or otherwise determine performance envelope 118 for current configuration 112 using information describing the performance capabilities of aircraft 102 for various configurations of aircraft 102 provided in performance capabilities database 120.

In the present application, including in the claims, performance capabilities 119 may refer to physical limits on the performance of aircraft 102. Alternatively, performance capabilities 119 may refer to limits on the performance of aircraft 102 that may be related to physical limits on the performance of aircraft 102. For example, without limitation, performance capabilities 119 may refer to limits on the performance of aircraft 102 defined by a margin of safety with respect to the physical limits on the performance of aircraft 102. As another example, performance capabilities 119 may refer to limits on the performance of aircraft 102 within which aircraft 102 is certified to be operated.

Performance envelope 118 may indicate various different performance capabilities 119 of aircraft 102. For example, without limitation, performance envelope 118 may include flight envelope 122, turn rate envelope 124, or both. Flight envelope 122 may indicate speed versus altitude performance capabilities of aircraft 102. Turn rate envelope 124 may indicate speed versus turn rate performance capabilities of aircraft 102.

Performance envelope selector 106 also may be configured to identify threshold of performance capabilities 126. Threshold of performance capabilities 126 may indicate a difference from performance capabilities 119 indicated by performance envelope 118. For, example, without limitation, threshold of performance capabilities 126 may be selected to define a margin of safety or other desired difference from performance capabilities 119 indicated by performance envelope 118.

Current performance identifier 108 may be configured to identify current performance 128 of aircraft 102. Current performance 128 may include various current performance characteristics of aircraft 102. For example, without limitation, current performance 128 may include speed 132 of aircraft 102, altitude 134 of aircraft 102, turn rate 136 of aircraft 102, bank angle 138 of aircraft 102, climb angle 140 of aircraft 102, or other current performance characteristics or combinations of current performance characteristics of aircraft 102.

Current performance identifier 108 may identify current performance 128 from information provided by various performance identification systems 141 on aircraft 102. Performance identification systems 141 may include any appropriate systems or devices on aircraft 102 for providing information from which current performance 128 of aircraft 102 may be identified or derived. For example, without limitation, performance identification systems 141 may include a speedometer and an altimeter for identifying speed 132 and altitude 134, respectively.

Current performance 128 may be identified directly from information provided by performance identification systems 141 or may be derived from information provided by performance identification systems 141. For example, without limitation, bank angle 138 and climb angle 140 may be identified directly from information provided by performance identification systems 141. Turn rate 136 may be derived from bank angle 138 and climb angle 140.

Display generator 110 may be configured to generate display 142 from performance envelope 118 and current performance 128. Display 142 may include two-dimensional representation of performance envelope 144 and performance indication 146 displayed on two-dimensional representation of performance envelope 144.

Two-dimensional representation of performance envelope 144 may be a two-dimensional representation of performance envelope 118 selected by performance envelope selector 106. For example, without limitation, two-dimensional representation of performance envelope 144 may include a two-dimensional representation of flight envelope 122, a two-dimensional representation of turn rate envelope 124, or both. Two-dimensional representation of performance envelope 144 may include a two dimensional representation of performance envelope 118 for current configuration 112, a two-dimensional representation of performance envelope 118 for a configuration of aircraft 102 other than current configuration 112, or both.

Performance indication 146 may be of any appropriate shape and size. The position of performance indication 146 on two-dimensional representation of performance envelope 144 indicates current performance 128 of aircraft 102 with respect to performance envelope 118. For example, without limitation, the position of performance indication 146 on two-dimensional representation of performance envelope 144 may indicate speed 132 and altitude 134 of aircraft 102 with respect to flight envelope 122, speed 132 and turn rate 136 of aircraft 102 with respect to turn rate envelope 124, or both.

Display generator 110 also may be configured to display warning indication 148 in response to current performance 128 exceeding threshold of performance capabilities 126. For example, without limitation, warning indication 148 may include changing the color, flashing, or changing other characteristics or combinations of characteristics of the display of performance indication 146 in response to current performance 128 exceeding threshold of performance capabilities 126.

Display 142 may be presented on any appropriate display device 150. For example, without limitation, display 142 may be presented to a pilot or other flight crew of aircraft 102 on display device 150 that is part of flight deck display 152 on the flight deck of aircraft 102.

The illustration of FIG. 1 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

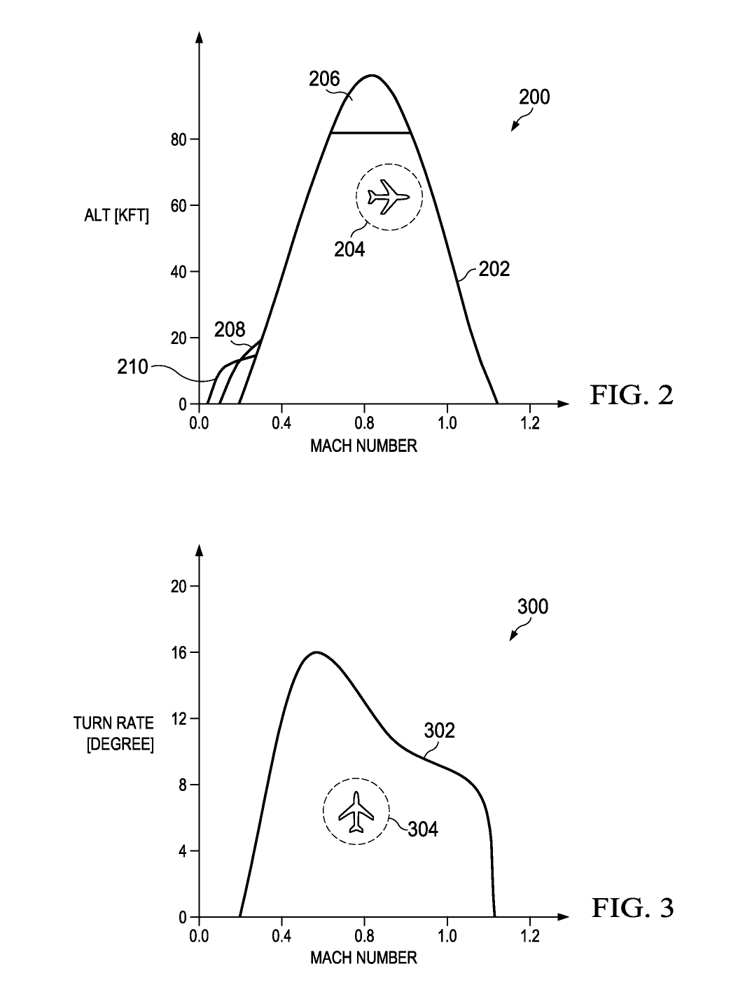

Turning now to FIG. 2, an illustration of a flight envelope display is depicted in accordance with an illustrative embodiment. In this example, flight envelope display 200 is an example of one implementation of display 142 in FIG. 1.

In this example, flight envelope display 200 includes two-dimensional representation of flight envelope 202 and performance indication 204. Two-dimensional representation of flight envelope 202 indicates speed versus altitude performance capabilities of an aircraft. The position of performance indication 204 on two-dimensional representation of flight envelope 202 indicates the current speed and altitude of the aircraft with respect to the flight envelope. In this example, restricted area 206 of the flight envelope also is identified on two-dimensional representation of flight envelope 202.

Two-dimensional representation of flight envelope 202 may indicate the flight envelope for the current configuration of an aircraft. For example, two-dimensional representation of flight envelope 202 may indicate the flight envelope for current flap settings of the aircraft. Two-dimensional representation of flight envelope 202 also may indicate the flight envelope for other configurations of the aircraft. In this example, portions 208 and 210 of two-dimensional representation of flight envelope 202 indicate changes to the flight envelope for other flap settings. Thus, a pilot may use flight envelope display 200 to visualize the effect of changing flap settings on the flight envelope for the aircraft.

Turning now to FIG. 3, an illustration of a turn rate envelope display is depicted in accordance with an illustrative embodiment. In this example, turn rate envelope display 300 is another example of one implementation of display 142 in FIG. 1.

In this example, turn rate envelope display 300 includes two-dimensional representation of turn rate envelope 302 and performance indication 304. Two-dimensional representation of turn rate envelope 302 indicates speed versus turn rate performance capabilities of an aircraft. The position of performance indication 304 on two-dimensional representation of turn rate envelope 302 indicates the current speed and turn rate of the aircraft with respect to the turn rate envelope.

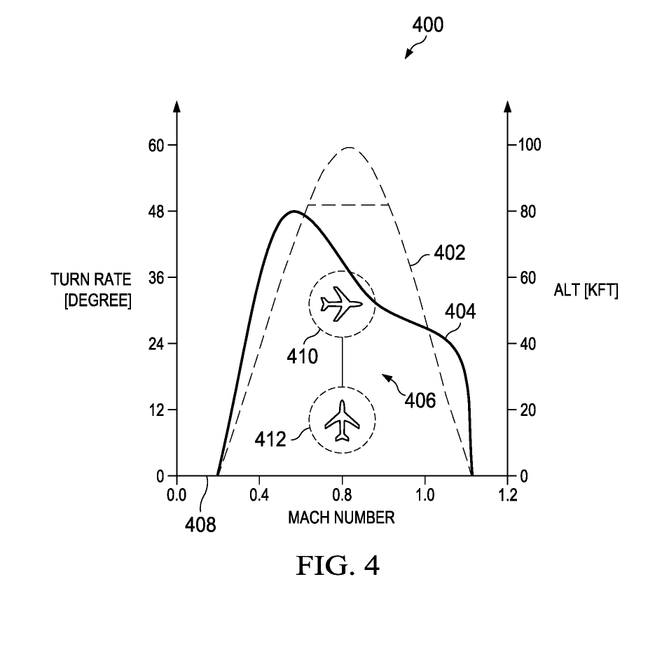

Turning now to FIG. 4, an illustration of a combined flight envelope and turn rate envelope display is depicted in accordance with an illustrative embodiment. In this example, display 400 is another example of one implementation of display 142 in FIG. 1.

In this example, display 400 includes two-dimensional representation of flight envelope 402, two-dimensional representation of turn rate envelope 404, and performance indication 406. Two-dimensional representation of flight envelope 402 indicates speed versus altitude performance capabilities of an aircraft. Two-dimensional representation of turn rate envelope 404 indicates speed versus turn rate performance capabilities of the aircraft. In this example, two-dimensional representation of flight envelope 402 and two-dimensional representation of turn rate envelope 404 are displayed at the same time with respect to common x-axis 408 indicating speed.

In this example, performance indication 406 comprises first performance indication 410 and second performance indication 412. The position of first performance indication 410 with respect to two-dimensional representation of flight envelope 402 indicates the current speed and altitude of the aircraft with respect to the flight envelope. The position of second performance indication 412 with respect to two-dimensional representation of turn rate envelope 404 indicates the current speed and turn rate of the aircraft with respect to the turn rate envelope. In this example, first performance indication 410 and second performance indication 412 move together in parallel with respect to x-axis 408 as the current speed of the aircraft changes.

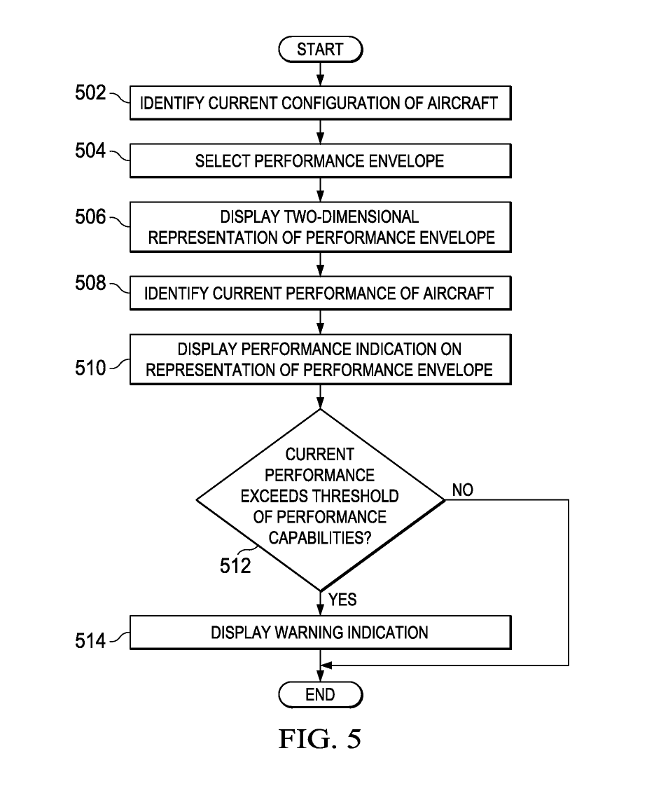

Turning now to FIG. 5, an illustration of a flowchart of a process for displaying aircraft performance is depicted in accordance with an illustrative embodiment. The process in FIG. 5 may be implemented, for example, in aircraft performance display system 100 in FIG. 1.

The process may begin by identifying the current configuration of an aircraft (operation 502). For example, without limitation, operation 502 may include identifying the current flap settings of the aircraft. Based on the current configuration of the aircraft, a performance envelope then may be selected (operation 504). The performance envelope indicates performance capabilities of the aircraft for the current configuration of the aircraft. For example, without limitation, the performance envelope may be a flight envelope, a turn rate envelope, or both. A two-dimensional representation of the performance envelope then may be displayed (operation 506).

Current performance of the aircraft may be identified (operation 508). A performance indication of the current performance then may be displayed on the representation of the performance envelope (operation 510). The position of the performance indication on the representation of the performance envelope indicates the current performance with respect to the performance envelope.

It then may be determined whether the current performance of the aircraft exceeds a threshold of performance capabilities of the aircraft (operation 512). If the current performance does not exceed the threshold of performance capabilities the process may terminate. If the current performance does exceed the threshold of performance capabilities a warning indication may be displayed (operation 514) with the process terminating thereafter. For example, without limitation, operation 514 may include changing the color, flashing, or changing another characteristic or combination of characteristics of the performance indication displayed in operation 510.

One or more of the illustrative embodiments provide a capability that allows a flight crew to assess current aircraft performance characteristics with reference to a currently applicable flight envelope. The currently applicable flight envelope may be selected based on the current configuration of the aircraft, such as the current flap settings. The illustrative embodiments allow the flight crew to identify margins and safety buffers at one view without having to combine information from different sources.

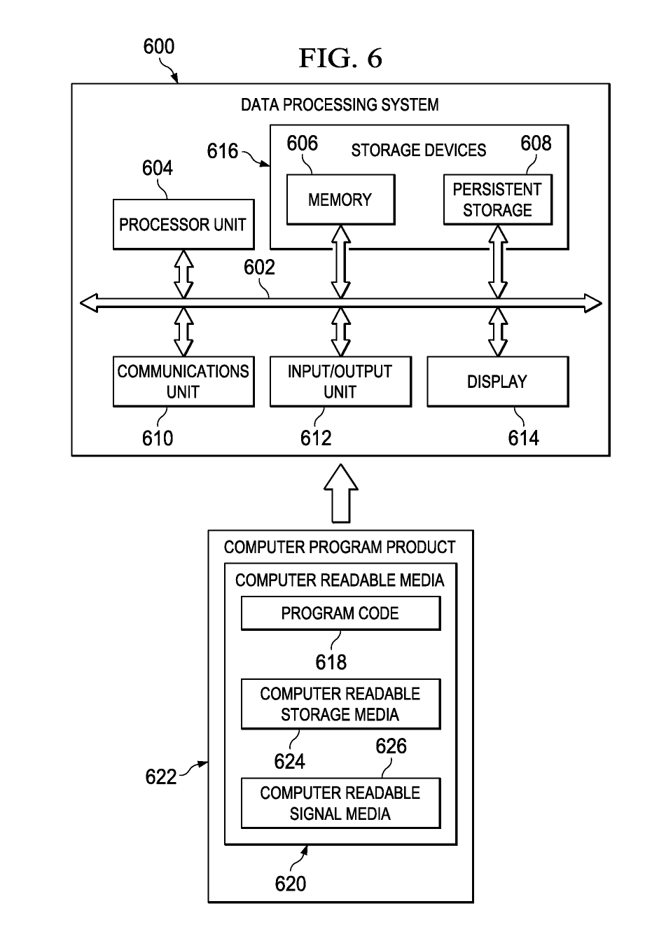

Turning now to FIG. 6, an illustration of a block diagram of a data processing system is depicted in accordance with an illustrative embodiment. In this example, data processing system 600 is an example of one implementation of a data processing system for implementing aircraft performance display system 100 in FIG. 1.

In this illustrative example, data processing system 600 includes communications fabric 602. Communications fabric 602 provides communications between processor unit 604, memory 606, persistent storage 608, communications unit 610, input/output (I/O) unit 612, and display 614. Memory 606, persistent storage 608, communications unit 610, input/output (I/O) unit 612, and display 614 are examples of resources accessible by processor unit 604 via communications fabric 602.

Processor unit 604 serves to run instructions for software that may be loaded into memory 606. Processor unit 604 may be a number of processors, a multi-processor core, or some other type of processor, depending on the particular implementation. Further, processor unit 604 may be implemented using a number of heterogeneous processor systems in which a main processor is present with secondary processors on a single chip. As another illustrative example, processor unit 604 may be a symmetric multi-processor system containing multiple processors of the same type.

Memory 606 and persistent storage 608 are examples of storage devices 616. A storage device is any piece of hardware that is capable of storing information, such as, for example, without limitation, data, program code in functional form, and other suitable information either on a temporary basis or a permanent basis. Storage devices 616 also may be referred to as computer readable storage devices in these examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these examples, provides for communications with other data processing systems or devices. In these examples, communications unit 610 is a network interface card. Communications unit 610 may provide communications through the use of either or both physical and wireless communications links.

Input/output (I/O) unit 612 allows for input and output of data with other devices that may be connected to data processing system 600. For example, input/output (I/O) unit 612 may provide a connection for user input through a keyboard, a mouse, and/or some other suitable input device. Further, input/output (I/O) unit 612 may send output to a printer. Display 614 provides a mechanism to display information to a user.

Instructions for the operating system, applications, and/or programs may be located in storage devices 616, which are in communication with processor unit 604 through communications fabric 602. In these illustrative examples, the instructions are in a functional form on persistent storage 608. These instructions may be loaded into memory 606 for execution by processor unit 604. The processes of the different embodiments may be performed by processor unit 604 using computer-implemented instructions, which may be located in a memory, such as memory 606.

These instructions are referred to as program instructions, program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these examples. In one example, computer readable media 620 may be computer readable storage media 624 or computer readable signal media 626.

Computer readable storage media 624 may include, for example, an optical or magnetic disk that is inserted or placed into a drive or other device that is part of persistent storage 608 for transfer onto a storage device, such as a hard drive, that is part of persistent storage 608. Computer readable storage media 624 also may take the form of a persistent storage, such as a hard drive, a thumb drive, or a flash memory, that is connected to data processing system 600. In some instances, computer readable storage media 624 may not be removable from data processing system 600.

In these examples, computer readable storage media 624 is a physical or tangible storage device used to store program code 618 rather than a medium that propagates or transmits program code 618. Computer readable storage media 624 is also referred to as a computer readable tangible storage device or a computer readable physical storage device. In other words, computer readable storage media 624 is a media that can be touched by a person.

Alternatively, program code 618 may be transferred to data processing system 600 using computer readable signal media 626. Computer readable signal media 626 may be, for example, a propagated data signal containing program code 618. For example, computer readable signal media 626 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 618 may be downloaded over a network to persistent storage 608 from another device or data processing system through computer readable signal media 626 for use within data processing system 600. For instance, program code stored in a computer readable storage medium in a server data processing system may be downloaded over a network from the server to data processing system 600. The data processing system providing program code 618 may be a server computer, a client computer, or some other device capable of storing and transmitting program code 618.

The different components illustrated for data processing system 600 are not meant to provide architectural limitations to the manner in which different embodiments may be implemented. The different illustrative embodiments may be implemented in a data processing system including components in addition to and/or in place of those illustrated for data processing system 600. Other components shown in FIG. 6 can be varied from the illustrative examples shown. The different embodiments may be implemented using any hardware device or system capable of running program code. As one example, data processing system 600 may include organic components integrated with inorganic components and/or may be comprised entirely of organic components excluding a human being. For example, a storage device may be comprised of an organic semiconductor.

In another illustrative example, processor unit 604 may take the form of a hardware unit that has circuits that are manufactured or configured for a particular use. This type of hardware may perform operations without needing program code to be loaded into a memory from a storage device to be configured to perform the operations.

For example, when processor unit 604 takes the form of a hardware unit, processor unit 604 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 618 may be omitted, because the processes for the different embodiments are implemented in a hardware unit.

In still another illustrative example, processor unit 604 may be implemented using a combination of processors found in computers and hardware units. Processor unit 604 may have a number of hardware units and a number of processors that are configured to run program code 618. With this depicted example, some of the processes may be implemented in the number of hardware units, while other processes may be implemented in the number of processors.

In another example, a bus system may be used to implement communications fabric 602 and may be comprised of one or more buses, such as a system bus or an input/output bus. Of course, the bus system may be implemented using any suitable type of architecture that provides for a transfer of data between different components or devices attached to the bus system.

Additionally, communications unit 610 may include a number of devices that transmit data, receive data, or both transmit and receive data. Communications unit 610 may be, for example, a modem or a network adapter, two network adapters, or some combination thereof. Further, a memory may be, for example, memory 606, or a cache, such as that found in an interface and memory controller hub that may be present in communications fabric 602.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description and is not intended to be exhaustive or to limit the embodiments in the form disclosed. Many modifications and variations will be apparent to those of ordinary skill in the art. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for displaying aircraft performance characteristics, comprising:
displaying a two-dimensional representation of a performance envelope indicating performance capabilities of an aircraft;
identifying a current performance of the aircraft; and
displaying a performance indication of the current performance with respect to the performance envelope on the two-dimensional representation of the performance envelope, wherein a position of the performance indication on the two-dimensional representation of the performance envelope indicates the current performance with respect to the performance envelope.

2. The method of claim 1 further comprising:
identifying a current configuration of the aircraft; and
selecting the performance envelope based on the current configuration of the aircraft.

3. The method of claim 2, wherein the current configuration of the aircraft comprises a flap configuration of the aircraft.

4. The method of claim 1 further comprising:
displaying a warning indication on the two-dimensional representation of the performance envelope in response to the current performance exceeding a threshold of the performance capabilities.

5. The method of claim 4, wherein displaying the warning indication comprises changing a color of the performance indication in response to the current performance exceeding the threshold of the performance capabilities.

6. The method of claim 1, wherein the performance envelope is a flight envelope and the two-dimensional representation of the performance envelope comprises a display of speed versus altitude.

7. The method of claim 1, wherein the performance envelope is a turn rate envelope and the two-dimensional representation of the performance envelope comprises a display of speed versus turn rate.

8. An apparatus, comprising:
a current performance identifier configured to identify a current performance of an aircraft; and
a display generator configured to display a two-dimensional representation of a performance envelope indicating performance capabilities of the aircraft and to display a performance indication of the current performance with respect to the performance envelope on the two-dimensional representation of the performance envelope, wherein a position of the performance indication on the two-dimensional representation of the performance envelope indicates the current performance with respect to the performance envelope.

9. The apparatus of claim 8 further comprising:
a current configuration identifier configured to identify a current configuration of the aircraft; and
a performance envelope selector configured to select the performance envelope based on the current configuration of the aircraft.

10. The apparatus of claim 9, wherein the current configuration of the aircraft comprises a flap configuration of the aircraft.

11. The apparatus of claim 8, wherein the display generator is further configured to display a warning indication on the two-dimensional representation of the performance envelope in response to the current performance exceeding a threshold of the performance capabilities.

12. The apparatus of claim 11, wherein the display generator is configured to change a color of the performance indication in response to the current performance exceeding the threshold of the performance capabilities.

13. The apparatus of claim 8, wherein the performance envelope is a flight envelope and the two-dimensional representation of the performance envelope comprises a display of speed versus altitude.

14. The apparatus of claim 8, wherein the performance envelope is a turn rate envelope and the two-dimensional representation of the performance envelope comprises a display of speed versus turn rate.

15. A method for displaying aircraft performance characteristics, comprising:
displaying a two-dimensional representation of a flight envelope for an aircraft, wherein the two-dimensional representation of the flight envelope comprises a display of speed versus altitude performance capabilities of the aircraft;
identifying a current speed and a current altitude of the aircraft; and
displaying a first performance indication of the current speed and the current altitude on the two-dimensional representation of the flight envelope, wherein a position of the first performance indication on the two-dimensional representation of the flight envelope indicates the current speed and the current altitude with respect to the flight envelope.

16. The method of claim 15 further comprising:
identifying a current configuration of the aircraft; and
selecting the flight envelope based on the current configuration of the aircraft.

17. The method of claim 16, wherein the current configuration of the aircraft comprises a flap configuration of the aircraft.

18. The method of claim 15 further comprising:
displaying a warning indication on the two-dimensional representation of the flight envelope in response to the current speed and the current altitude exceeding a threshold of the speed versus altitude performance capabilities.

19. The method of claim 18, wherein displaying the warning indication comprises changing a color of the first performance indication in response to the current speed and the current altitude exceeding the threshold of the speed versus altitude performance capabilities.

20. The method of claim 15 further comprising:
displaying a two-dimensional representation of a turn rate envelope for the aircraft on the two-dimensional representation of the flight envelope, wherein the two dimensional representation of the turn rate envelope comprises a display of speed versus turn rate performance capabilities of the aircraft;
identifying a current turn rate of the aircraft; and
displaying a second performance indication of the current speed and the current turn rate on the two-dimensional representation of the turn rate envelope, wherein the position of the second performance indication on the two-dimensional representation of the turn rate envelope indicates the current speed and the current turn rate with respect to the turn rate envelope.
